(19) United States
(12) Patent Application Publication
(10) Pub. No.: US 2010/0192112 A1
(43) Pub. Date: Jul. 29, 2010

(54) DIAGNOSTIC APPARATUS FOR SEMICONDUCTOR DEVICE, DIAGNOSTIC METHOD FOR SEMICONDUCTOR DEVICE, AND MEDIUM STORING DIAGNOSTIC PROGRAM FOR SEMICONDUCTOR DEVICE

(75) Inventor: Masato Nakazato, Kawasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/563,512

(22) Filed: Sep. 21, 2009

(30) Foreign Application Priority Data
Jan. 29, 2009 (JP) 2009-18298

(51) Int. Cl. G06F 17/50

(52) U.S. Cl. 716/4

(57) ABSTRACT

A diagnostic apparatus for semiconductor device includes a fault cell list generation unit configured to extract fault cell candidates corresponding to light emission position information, to generate a fault cell list on the basis of the light emission image information, and to generate a transistor circuit network list showing connection relations of the transistors and a diagnostic pattern, a light emission point dictionary generation unit configured to execute simulation concerning a substrate current of a transistor and to generate a light emission point dictionary comprising a substrate current of the transistor, a fault circuit network extraction unit configured to extract a second fault circuit network candidate from among the first fault circuit network candidates, and an output unit configured to output the second fault circuit network candidate.

### CROSS-REFERENCE TO RELATED APPLICATION

This application is based upon and claims the benefit of priority from the prior Japanese Patent Application No. 2009-18298, filed on Jan. 29, 2009; the entire contents of which are incorporated herein by reference.

### BACKGROUND OF THE INVENTION

1. Field of the Invention

The present invention relates to a diagnostic apparatus for semiconductor device, a diagnostic method for semiconductor device, and a medium storing diagnostic program for semiconductor device. In particular, the present invention relates to a diagnostic apparatus for semiconductor device, a diagnostic method for semiconductor device, and a medium storing diagnostic program for semiconductor device, for implementing the diagnostic method, using a result of light emission analysis.

2. Related Art

As an analysis method for locating a fault point when diagnosing a semiconductor device, light emission analysis is known. A designer can observe abnormal light emission of a transistor due to a fault, with comparative ease without contact and destruction by implementing light emission analysis (see Japanese Patent laid-open Publication 2003-86689).

A transistor corresponding to an abnormal light emission point of light emission image information acquired by light emission analysis does not necessarily include a fault, but there is also a possibility that a fault has occurred in a transistor in the preceding stage (other transistor) or interconnection leading to the transistor in the preceding stage. When diagnosing a semiconductor device by using the light emission analysis, therefore, a designer must locate the fault point by tracing back a circuit network concerning connection of a transistor (hereafter referred to as “transistor circuit network”) including a transistor corresponding to an abnormal light emission point as a reference, on the basis of light emission image information.

As the semiconductor device manufacturing process shrinks in size in recent years, however, the transistor size tends to be shrunk. Therefore, the light emission size in light emission image information generated by the conventional light emission analyzing apparatus becomes large relatively to the transistor size. As a result, it becomes difficult for a designer to locate the abnormal light emission point in the light emission image information.

Furthermore, in the light emission analysis, an accumulated value of a light emission quantity when a diagnostic pattern is applied to the semiconductor device repeatedly is acquired.

Therefore, not only the light emission quantity of abnormal light emission emitted by transistors including a fault but also a minute light emission quantity emitted by normal transistors is included in the accumulated value. As a result, the light emission quantity of abnormal light emission of a transistor which might include a fault can not be distinguished from the minute light emission quantity of light emission emitted by the normal transistors, resulting in low accuracy of the analysis result.

Furthermore, the time period required for the back trace is prolonged as the transistor circuit network becomes large-scaled and complicated in recent years.

On the other hand, as a technique compensating the problems of the conventional light emission analysis technique, a technique for diagnosing whether there is a fault not only on a transistor but also on interconnection or on a cell connected to the interconnection using light emission image information of an emission microscope (see Japanese Patent laid-open Publication 2004-45132).

In Japanese Patent laid-open Publication 2004-45132 as well, however, analysis is conducted by using light emission image information of an emission microscope. If the resolution of the light emission image information of the emission microscope arrives at a limit, therefore, it becomes difficult to locate a fault point from the light emission image information in the same way as the conventional light emission analysis technique.

In other words, in the conventional light emission analysis technique, the time period required for the diagnosis of the semiconductor device becomes long and the diagnosis accuracy of the semiconductor device becomes deteriorated, and various problems are caused by the low accuracy.

### BRIEF SUMMARY OF THE INVENTION

According to a first aspect of the present invention, there is provided a diagnostic apparatus for semiconductor device comprising:

a fault cell list generation unit configured to extract fault cell candidates corresponding to light emission position information in light emission image information and to generate a fault cell list on the basis of the light emission image information comprising light emission quantities and the light emission position information of transistors of respective cells in a semiconductor device acquired by light emission analysis and design information comprising a layout of the semiconductor device, and to generate a transistor circuit network list showing connection relations of the transistors and a diagnostic pattern on the basis of the design information;

a light emission point dictionary generation unit configured to execute simulation concerning a substrate current of a transistor in a cell with a first fault circuit network candidate inserted therein and to generate a light emission point dictionary comprising a substrate current of the transistor in the cell with the first fault circuit network candidate inserted therein, on the basis of the design information, the diagnostic pattern and a fault dictionary;

a fault circuit network extraction unit configured to extract a second fault circuit network candidate from among the first fault circuit network candidates, on the basis of the light emission image information, the design information and the light emission point dictionary; and

an output unit configured to output the second fault circuit network candidate.

According to a second aspect of the present invention, there is provided a diagnostic method for semiconductor device comprising:

generating a fault cell list corresponding to light emission position information in light emission image information, on the basis of the light emission image information comprising light emission quantities and the light emission position information of transistors of respective cells in a semiconductor device acquired by light emission analysis and design information comprising a layout of the semiconductor device;

generating a transistor circuit network list showing connection relations of the transistors and a diagnostic pattern on the basis of the design information;

executing simulation concerning a substrate current of a transistor in a cell with a first fault circuit network candidate inserted therein, on the basis of the design information, the diagnostic pattern and a fault dictionary, to generate a light emission point dictionary comprising a substrate current of the transistor in the cell with the first fault circuit network candidate inserted therein;

extracting a second fault circuit network candidate from among the first fault circuit network candidates, on the basis of the light emission image information, the design information and the light emission point dictionary; and

outputting the second fault circuit network candidate.

According to a third aspect of the present invention, there is provided a medium storing a diagnostic program for semiconductor device, the program comprising:

a fault cell list generation instruction configured to extract fault cell candidates corresponding to light emission position information in light emission image information and to generate a fault cell list on the basis of the light emission image information comprising light emission quantities and the light emission position information of transistors of respective cells in a semiconductor device acquired by light emission analysis and design information comprising a layout of the semiconductor device, and to generate a transistor circuit network list showing connection relations of the transistors and a diagnostic pattern on the basis of the design information;

a light emission point dictionary generation instruction configured to execute simulation concerning a substrate current of a transistor in a cell with a first fault circuit network candidate inserted therein and to generate a light emission point dictionary comprising a substrate current of the transistor in the cell with the first fault circuit network candidate inserted therein, on the basis of the design information, the diagnostic pattern and a fault dictionary;

a fault circuit network extraction instruction configured to extract a second fault circuit network candidate from among the first fault circuit network candidates, on the basis of the light emission image information, the design information and the light emission point dictionary; and

an output instruction configured to output the second fault circuit network candidate.

### BRIEF DESCRIPTION OF THE DRAWINGS

FIG. 1 is a block diagram showing a configuration of a diagnostic apparatus 10 according to the first embodiment of the present invention.

FIG. 2 is a schematic diagram showing an example of a light emission image which is an analysis result of light emission analysis conducted by using a typical light emission analyzing apparatus.

FIG. 3 is a schematic diagram showing a data structure of a light emission information file 16b shown in FIG. 1 according to the first embodiment of the present invention.

FIG. 4 is a schematic diagram showing an example of a layout of a semiconductor device to be made a diagnosis according to the first embodiment of the present invention.

FIG. 5 is a flow chart showing a procedure of diagnostic processing according to the first embodiment of the present invention.

FIG. 6 is a schematic diagram showing a data structure of the fault cell list file 16d shown in FIG. 1 according to the first embodiment of the present invention.

FIG. 7 is a schematic diagram showing an example of a connection relation of a semiconductor device according to the first embodiment of the present invention.

FIG. 8 is a schematic diagram showing a data structure of the fault dictionary file 16e shown in FIG. 1 according to the first embodiment of the present invention.

FIG. 9 is a schematic diagram showing an example of application of a fault to a transistor circuit network list according to the first embodiment of the present invention.

FIG. 10 is a schematic diagram showing a data structure of the light emission point dictionary 16f shown in FIG. 1 according to the first embodiment of the present invention.

FIG. 11 is a graph showing relations between a substrate current and a light emission quantity of a transistor, which are experiment results.

FIG. 12 is a schematic diagram showing an example of comparison of a light emission pattern of a light emission image with a light emission pattern of a simulation result according to the first embodiment of the present invention.

FIG. 13 is a schematic diagram showing a data structure of the second fault circuit network candidate file 16g shown in FIG. 1 according to the first embodiment of the present invention.

FIG. 14 is a schematic diagram showing an example of an overlay image according to the first embodiment of the present invention.

FIG. 15 is a schematic diagram showing an example of a transistor circuit network list according to the first embodiment of the present invention.

FIG. 16 is a schematic diagram showing an example of a light emission image which is an analysis result of light emission analysis conducted by using a typical light emission analyzing apparatus.

FIG. 17 is a schematic diagram showing a layout of a semiconductor device to be made a diagnosis according to the second embodiment of the present invention.

FIG. 18 is a schematic diagram showing a data structure of the fault cell list file 16d shown in FIG. 1 according to the second embodiment of the present invention.

FIG. 19 is a schematic diagram showing an example of a data structure of the light emission point dictionary 16f shown in FIG. 1 according to the second embodiment of the present invention.

FIG. 20 is a schematic diagram showing an example of comparison of a light emission pattern of a light emission image with a light emission pattern of a simulation result according to the second embodiment of the present invention.

FIG. 21 is a schematic diagram showing a data structure of the second fault circuit network candidate file 16g shown in FIG. 1 according to the second embodiment of the present invention.

FIG. 22 is a schematic diagram showing an example of an overlay image according to the second embodiment of the present invention.

### DETAILED DESCRIPTION OF THE EMBODIMENTS

Hereafter, embodiments of the present invention will be described in detail.

### First Embodiment

A first embodiment of the present invention will now be described. The first embodiment of the present invention is an example of a diagnostic apparatus narrowing down a fault point every cell (a logic circuit including a plurality of transistors).

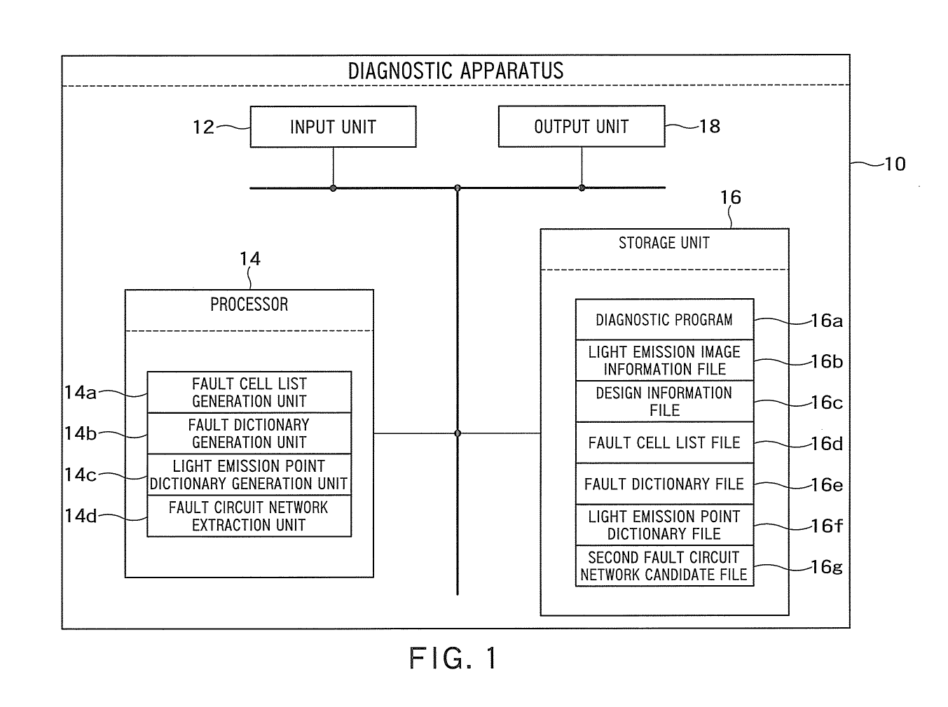

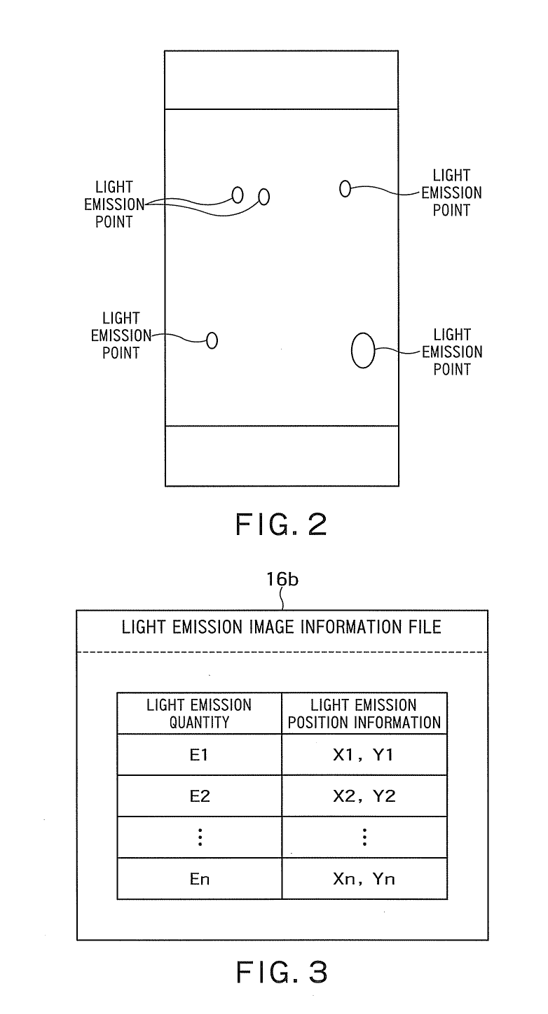

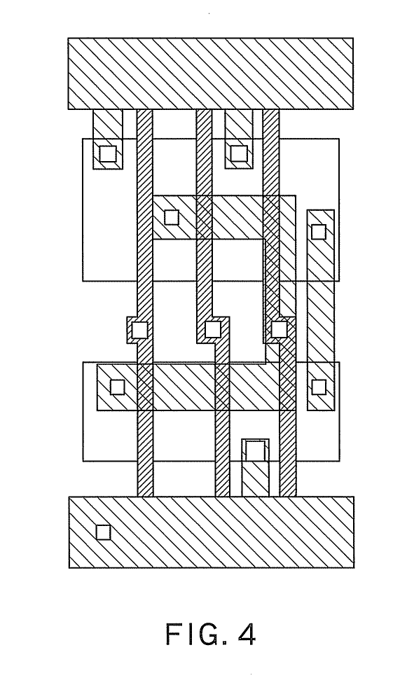

A configuration of a diagnostic apparatus according to the first embodiment of the present invention will now be described with reference to the drawings. FIG. 1 is a block diagram showing a configuration of a diagnostic apparatus 10 according to the first embodiment of the present invention. FIG. 2 is a schematic diagram showing an example of a light emission image which is an analysis result of light emission analysis conducted by using a typical light emission analyzing apparatus. FIG. 3 is a schematic diagram showing a data structure of a light emission information file 16b shown in FIG. 1 according to the first embodiment of the present invention. FIG. 4 is a schematic diagram showing an example of a layout of a semiconductor device to be made a diagnosis according to the first embodiment of the present invention.

As shown in FIG. 1, the diagnostic apparatus 10 according to the first embodiment of the present invention includes an input unit 12, a processor 14, a storage unit 16, and an output unit 18. Furthermore, the diagnostic apparatus 10 is configured to make a diagnosis of a semiconductor device using an analysis result of light emission analysis.

As shown in FIG. 1, the input unit 12 is configured to accept user's commands. For example, the input unit 12 is an input module such as a keyboard.

As shown in FIG. 1, the processor 14 is configured to execute a diagnostic program 16a stored in the storage unit 16 to implement a fault cell list generation unit 14a, a fault dictionary generation unit 14b, a light emission point dictionary generation unit 14c and a fault circuit network extraction unit 14d.

As shown in FIG. 1, the storage unit 16 is configured to store various kinds of information including a diagnostic program 16a for implementing the respective configurations in the processor 14, a light emission image information file 16b (see FIG. 3) storing light emission image information including a light emission quantity and light emission position information of a light emission image (see FIG. 2) which is an analysis result of light emission analysis conducted by using a typical light emission analyzing apparatus, a design information file 16c storing design information including a layout (see FIG. 4) of a semiconductor device formed of a plurality of cells, a fault cell list file 16d storing a fault cell list (described later), a fault dictionary file 16e storing a fault dictionary (described later), a light emission point dictionary file 16f storing a light emission point dictionary (described later), and a second fault circuit network candidate file 16g storing a second fault circuit network candidate (described later). Furthermore, the storage unit 16 is configured to function as a working memory for the processor 14 as well.

As shown in FIG. 1, the output unit 18 is configured to output a diagnosis result of diagnostic processing. For example, the output unit 18 is a display module such as a LCD (Liquid Crystal Display).

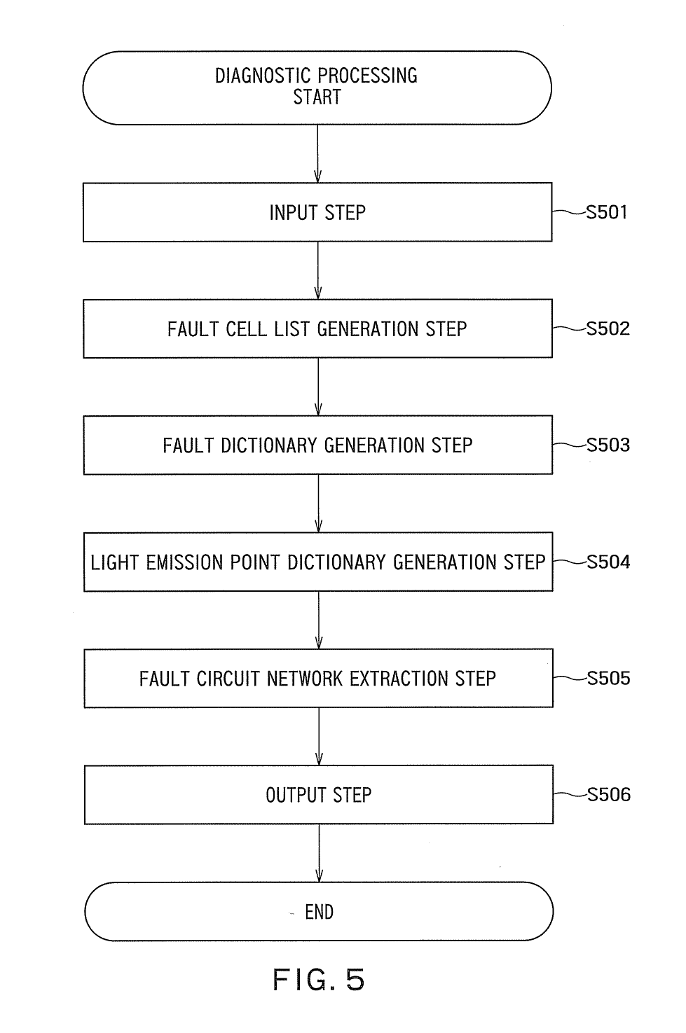

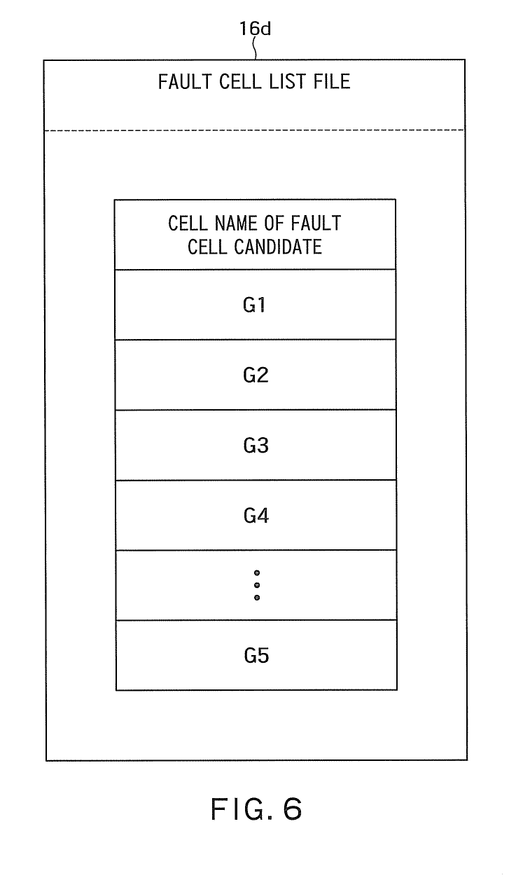

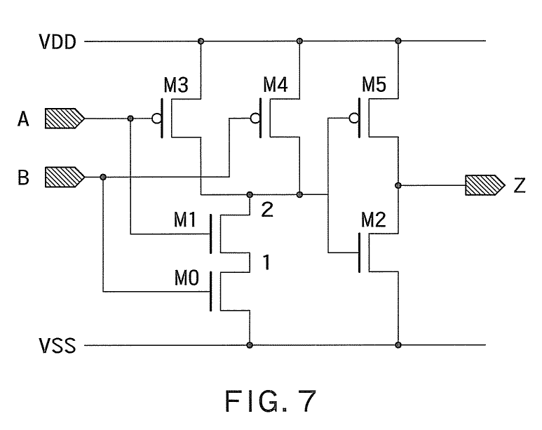

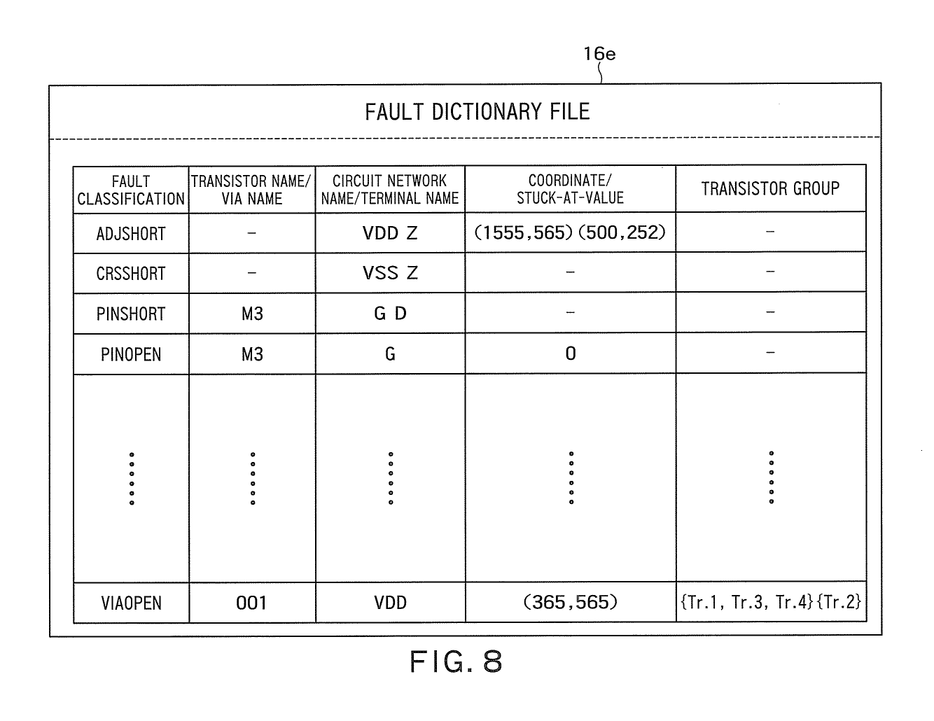

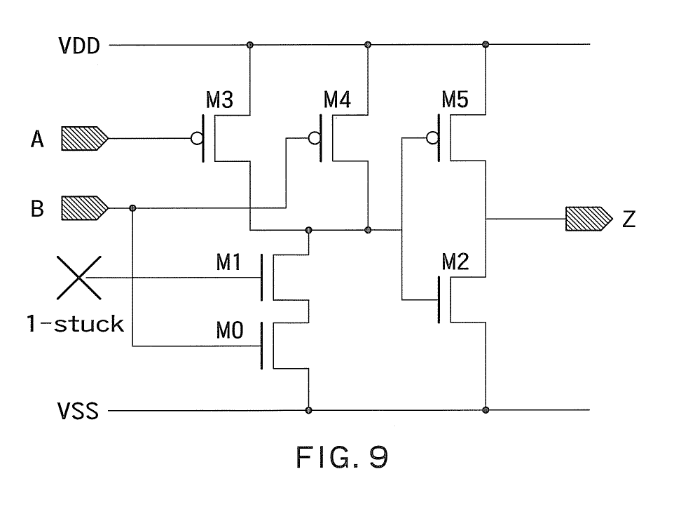

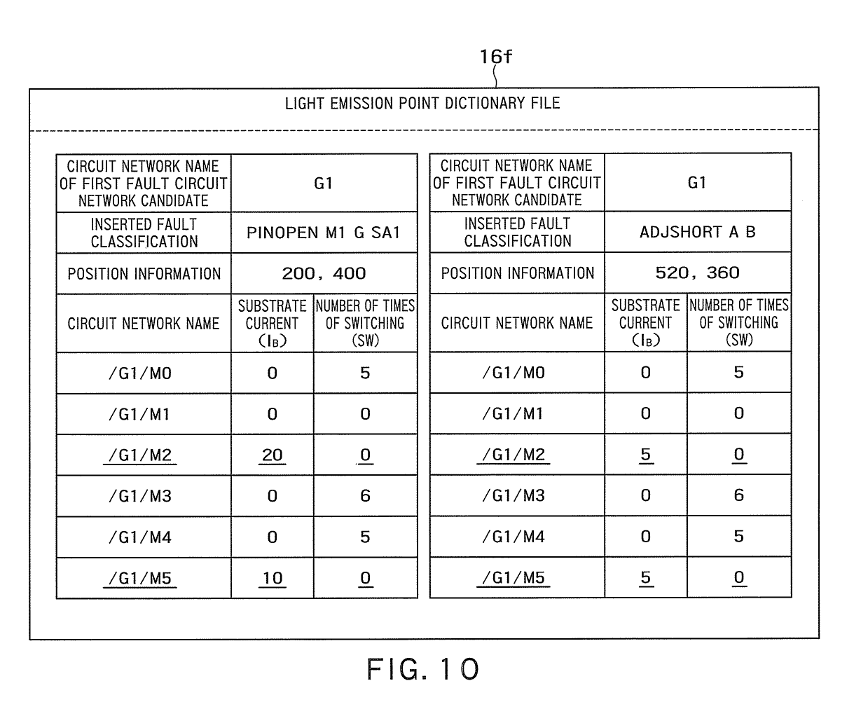

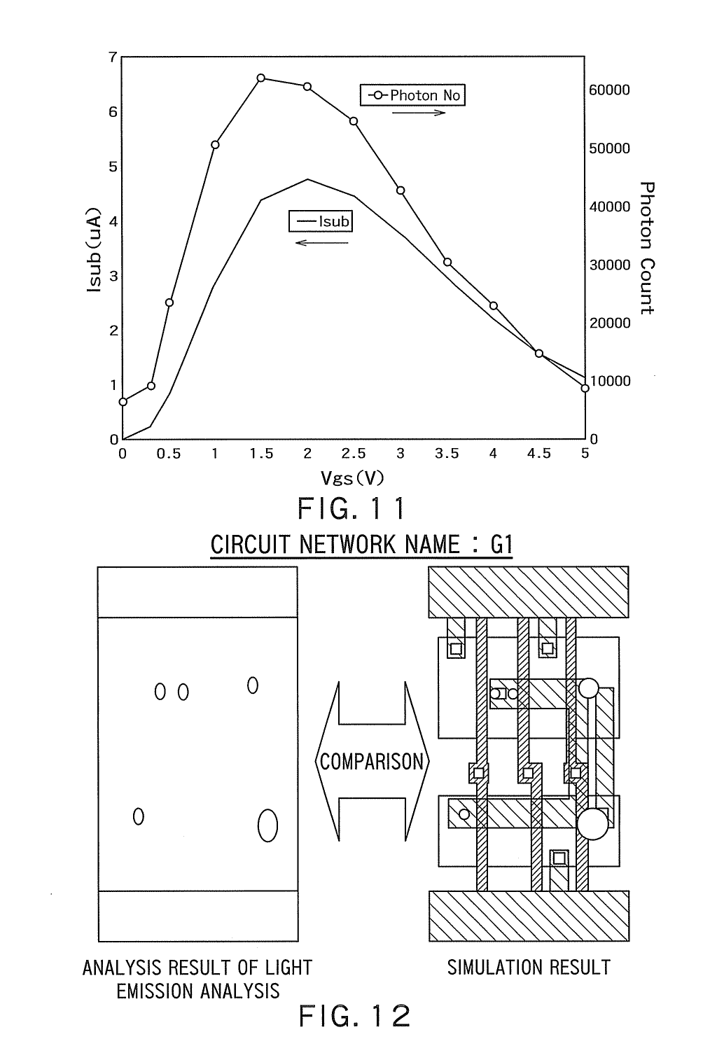

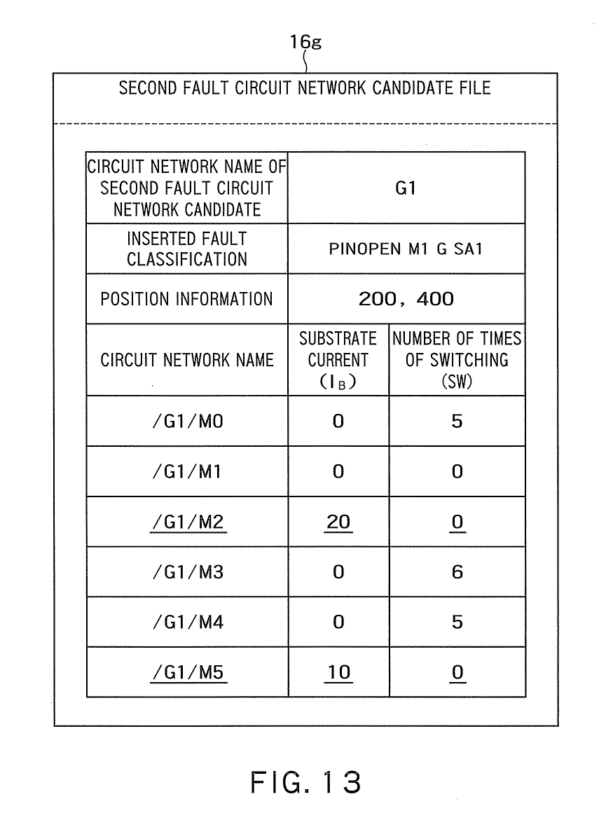

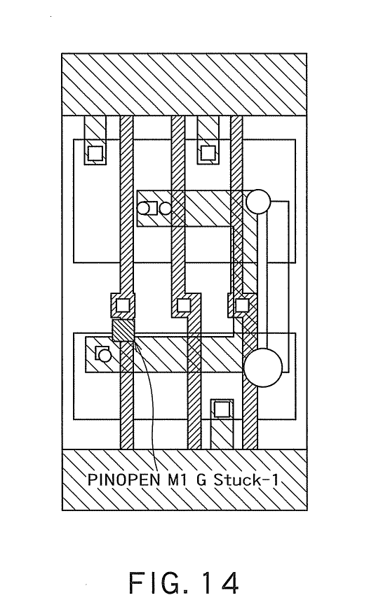

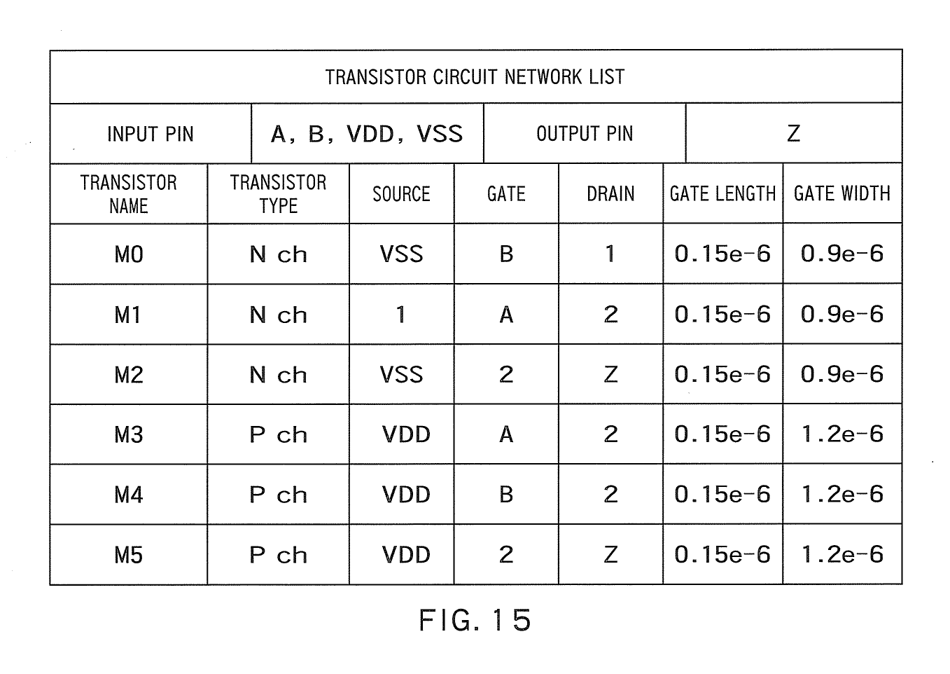

Operation of the diagnostic apparatus 10 according to the first embodiment of the present invention will now be described with reference to the drawings. FIG. 5 is a flow chart showing a procedure of diagnostic processing according to the first embodiment of the present invention. FIG. 6 is a schematic diagram showing a data structure of the fault cell list file 16d shown in FIG. 1 according to the first embodiment of the present invention. FIG. 7 is a schematic diagram showing an example of a connection relation of a semiconductor device according to the first embodiment of the present invention. FIG. 8 is a schematic diagram showing a data structure of the fault dictionary file 16e shown in FIG. 1 according to the first embodiment of the present invention. FIG. 9 is a schematic diagram showing an example of application of a fault to a transistor circuit network list according to the first embodiment of the present invention. FIG. 10 is a schematic diagram showing a data structure of the light emission point dictionary 16f shown in FIG. 1 according to the first embodiment of the present invention. FIG. 11 is a graph showing relations between a substrate current and a light emission quantity of a transistor, which are experiment results. FIG. 12 is a schematic diagram showing an example of comparison of a light emission pattern of a light emission image with a light emission pattern of a simulation result according to the first embodiment of the present invention. FIG. 13 is a schematic diagram showing a data structure of the second fault circuit network candidate file 16g shown in FIG. 1 according to the first embodiment of the present invention. FIG. 14 is a schematic diagram showing an example of an overlay image according to the first embodiment of the present invention. FIG. 15 is a schematic diagram showing an example of a transistor circuit network list according to the first embodiment of the present invention.

In the diagnostic apparatus according to the first embodiment of the present invention, an input step (S501) is first conducted as shown in FIG. 5. In the input step (S501), the input unit 12 accepts light emission image information and design information from the user's commands. The accepted light emission image information and design information are stored in the light emission image information file 16b and the design information file 16c, respectively.

Next, a fault cell list generation step (S502) is conducted as shown in FIG. 5. In the fault cell list generation step (S502), on the basis of light emission image information including light emission quantities and light emission position information of transistors of respective cells in the semiconductor device acquired by the light emission analysis and design information including the layout of the semiconductor device, the fault cell list generation unit 14a extracts fault cell candidates corresponding to the light emission position information in the light emission image information to generate a fault cell list, and generates all input-output pattern (hereafter referred to as “diagnostic pattern”) of cells in a transistor circuit network list (see FIG. 15) showing connection relations (see FIG. 7) of transistors and the fault cell list from the design information. For example, the fault cell list generation unit 14a stores cell names of fault cell candidates corresponding to light emission position information in the light emission image information file 16b in the fault cell list file 16d (see FIG. 6). In other words, the fault cell list represents information indicating fault cell candidates which can occur structurally on the layout of the semiconductor device.

Next, a fault dictionary generation step (S503) is conducted as shown in FIG. 5. In the fault dictionary generation step (S503), the fault dictionary generation unit 14b extracts first fault circuit network candidates having a possibility of a structural fault from among circuit networks of fault cell candidates to generate a fault dictionary, on the basis of the design information and the fault cell list. For example, if there is a circuit network provided in parallel within an adjacent distance specified in the user's commands, then the fault dictionary generation unit 14b extracts first fault circuit network candidates of an adjacent short circuit fault (ADJSHORT). If there is one set of layers intersecting each other (cross or run parallel), then the fault dictionary generation unit 14b extracts first fault circuit network candidates of intersection short circuit fault (CRSSHORT). If there is a short circuit between two terminals (gate terminal-source terminal, gate terminal-drain terminal or gate terminal-base terminal) of a transistor, then the fault dictionary generation unit 14b extracts first fault circuit network candidates of pin short circuit fault (PINSHORT). If the gate terminal, source terminal or the drain terminal of the transistor is not connected, then the fault dictionary generation unit 14b extracts first fault circuit network candidates of pin open circuit fault (PINOPEN). By the way, in the pin open circuit faults, there are “0-STUCK” in which the value of the circuit network is stuck at “0”, “1-STUCK” in which the value of the circuit network is stuck at “1”, and “HZ-STUCK” in which the value of the circuit network is stuck at high impedance. If a via connecting inter-layer interconnections is missing, then the fault dictionary generation unit 14b extracts first fault circuit network candidates of via open circuit fault (VIAOPEN). As shown in FIG. 8, the fault dictionary file 16e includes a fault classification, coordinate/stuck-at-value and a transistor group, every first fault circuit network (transistor name/via name, circuit network name/terminal name).

Next, a light emission point dictionary generation step (S504) is conducted as shown in FIG. 5. In the light emission point dictionary generation step (S504), on the basis of the light emission image information, design information, diagnostic pattern and fault dictionary, the light emission point dictionary generation unit 14c executes simulation concerning the substrate current and the number of times of switching of a transistor in a cell with the first fault circuit network candidate inserted therein to generate a light emission point dictionary including the substrate current and the number of times of switching of the transistor in the cell with the first fault circuit network candidate inserted therein. For example, the light emission point dictionary generation unit 14c selects a circuit network name of an arbitrary first fault circuit network candidate in the fault dictionary file 16e, applies a fault classification corresponding to the circuit network name to the transistor circuit network list (see FIG. 9), applies a diagnostic pattern to the transistor circuit network list, executes simulation concerning the substrate current and the number of times of switching of transistors, and stores a simulation result in the light emission point dictionary file 16f (see FIG. 10). As shown in FIG. 10, the light emission point dictionary includes identification information (circuit network name) of a first fault circuit network candidate, a fault classification inserted in the first fault circuit network candidate, position information of the first fault circuit network candidate, and a simulation result (a substrate current (I_{B}) and the number of times of switching (SW) of the transistor). By the way, FIG. 9 shows a fault in which a logical value at the gate terminal of a transistor “M1” is stuck at 1 (hereafter referred to as “stuck-at-logical-value-1 fault”). With respect to position information (200, 400) in a circuit network “/G1”, FIG. 10 indicates that the fault classification is the pin open circuit fault and the stuck-at-logical-value-1 fault and the fault point is the gate terminal of the transistor “M1”. With respect to position information (520, 360) in the circuit network “/G1”, FIG. 10 indicates that the fault classification is the circuit network short circuit fault and the fault point is present between a circuit network A and a circuit network B.

Next, a fault circuit network extraction step (S505) is conducted as shown in FIG. 5. In the fault circuit network extraction step (S505), on the basis of the light emission image information, design information and the light emission point dictionary, the fault circuit network extraction unit 14d extracts a second fault circuit network candidate from among the first fault circuit network candidates. Here, the fault circuit network extraction unit 14d compares an analysis result of light emission analysis with its simulation result using a correlation between the substrate current (Isub) and light emission quantity (photon) of a transistor shown in FIG. 11, and extracts first fault circuit network candidates, for which a light emission pattern (the light emission quantity and light emission position information in the light emission image information file 16b) of the analysis result of the light emission analysis nearly coincides with a light emission pattern of the simulation result, as a second fault circuit network candidate. For example, the fault circuit network extraction unit 14d compares the light emission pattern of the analysis result of the light emission analysis with the light emission pattern of the simulation result every transistor, and stores a first fault circuit network candidate in which they nearly coincide with each other in the comparison result in the second fault circuit network candidate file 16g. In the example shown in FIG. 12, the light emission pattern of the analysis result of the light emission analysis nearly coincides with the light emission pattern of the simulation result corresponding to the first fault circuit network candidate in the light emission point dictionary file 16f as a result of the comparison. Therefore, the fault circuit network extraction unit 14d stores the light emission point dictionary of the first fault circuit network candidate in the second fault circuit network candidate file 16g as the second fault circuit network candidate (see FIG. 13). With respect to all of the first fault circuit network candidates in the light emission point dictionary file 16f, the fault circuit network extraction unit 14d compares the light emission pattern of the analysis result of light emission analysis with the light emission pattern of the simulation result, and extracts a second fault circuit network candidate.

Next, an output step (S506) is conducted as shown in FIG. 5. In the output step (S506), the output unit 18 applies position information of the second fault circuit network candidate to the design information to generate a diagnostic image, and outputs the diagnostic image. For example, the output unit 18 combines a layout image of the design information in the design information file 16c, mark images every inserted fault classifications in the second fault circuit network candidate file 16g and a mark image indicating position information of the light emission point, to generate an overlay image (see FIG. 14), and outputs the overlay image as a diagnostic image (diagnostic result).

As shown in FIG. 5, the diagnostic processing according to the first embodiment of the present invention is ended after the output step (S506).

According to the first embodiment of the present invention, a first fault circuit network candidate for which the light emission pattern of the analysis result of the light emission analysis of the semiconductor device nearly coincides with the light emission pattern of the simulation result, that is, a difference between the light emission pattern due to fault operation of the semiconductor device and the light emission pattern due to normal operation of the semiconductor is lower than a predetermined value, is extracted as the second fault circuit network candidate. Even if it is difficult for the naked eye to distinguish the light emission pattern due to normal operation from the light emission pattern due to fault operation, therefore, the light emission point can be located easily. As a result, the time period required for diagnosing the semiconductor device is shortened and the accuracy is improved.

Furthermore, according to the first embodiment of the present invention, the light emission pattern of the analysis result of light emission analysis having a small size is compared with the light emission pattern of the simulation result of a cell unit having a large size. Even in the case where the size of the light emission pattern becomes small because the transistor size is small, therefore, the light emission point can be located easily. As a result, the time period required for diagnosing the semiconductor device is shortened and the accuracy is improved.

### Second Embodiment

A second embodiment of the present invention will now be described. The second embodiment of the present invention is an example of a diagnostic apparatus narrowing down a fault point from the whole semiconductor device.

A configuration of a diagnostic apparatus according to the second embodiment of the present invention is similar to that according to the first embodiment of the present invention (see FIG. 1).

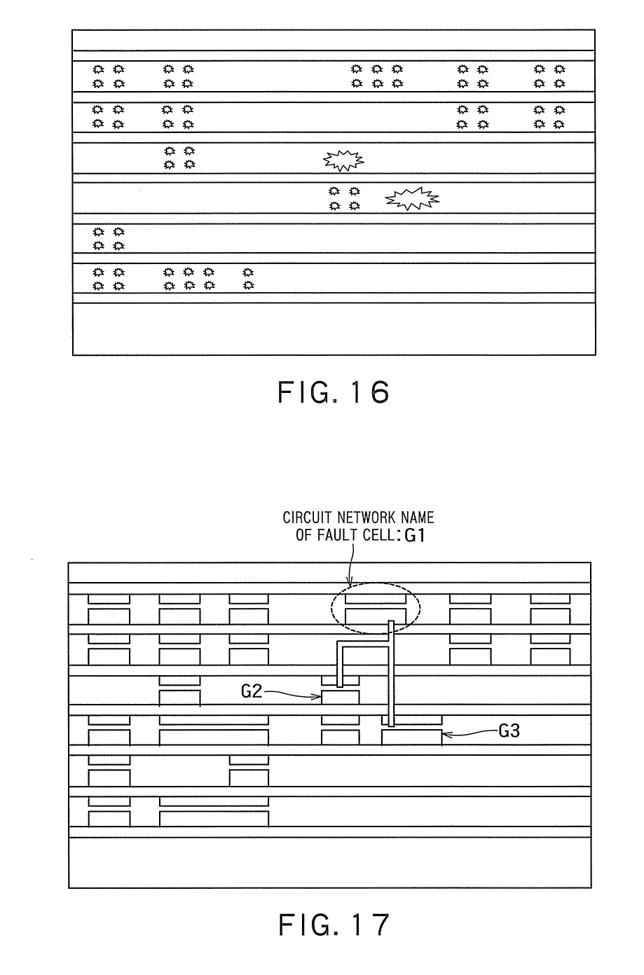

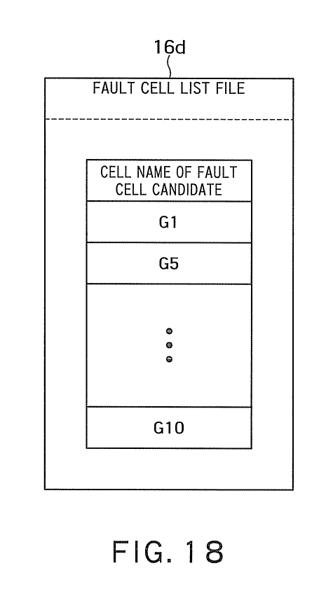

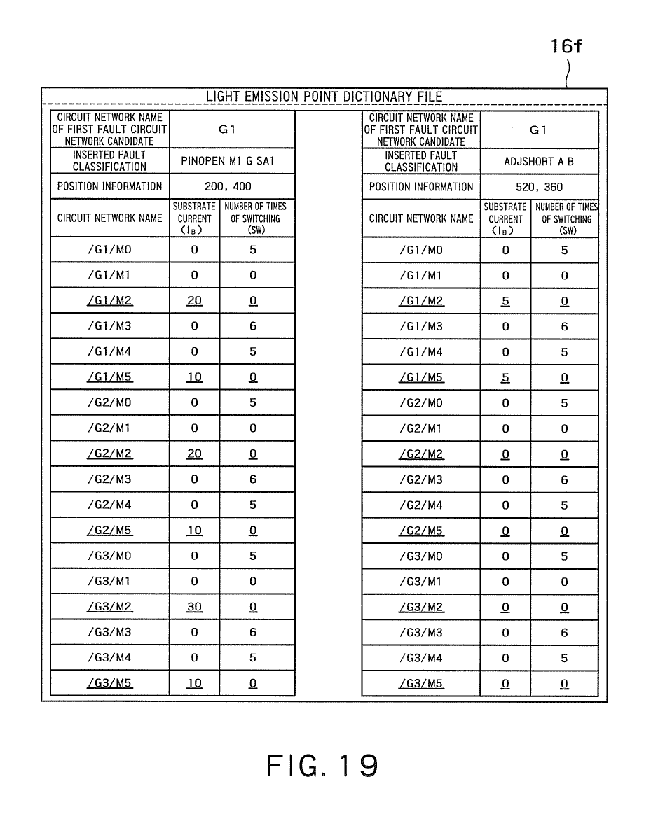

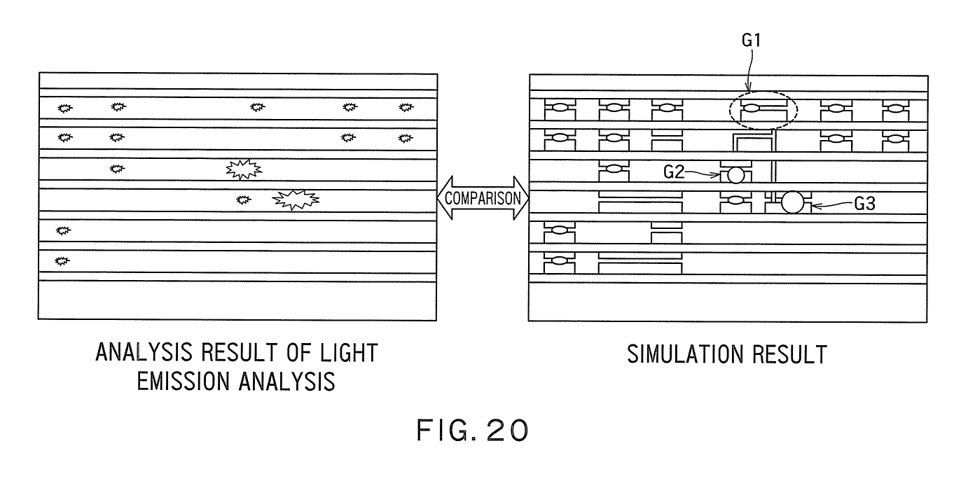

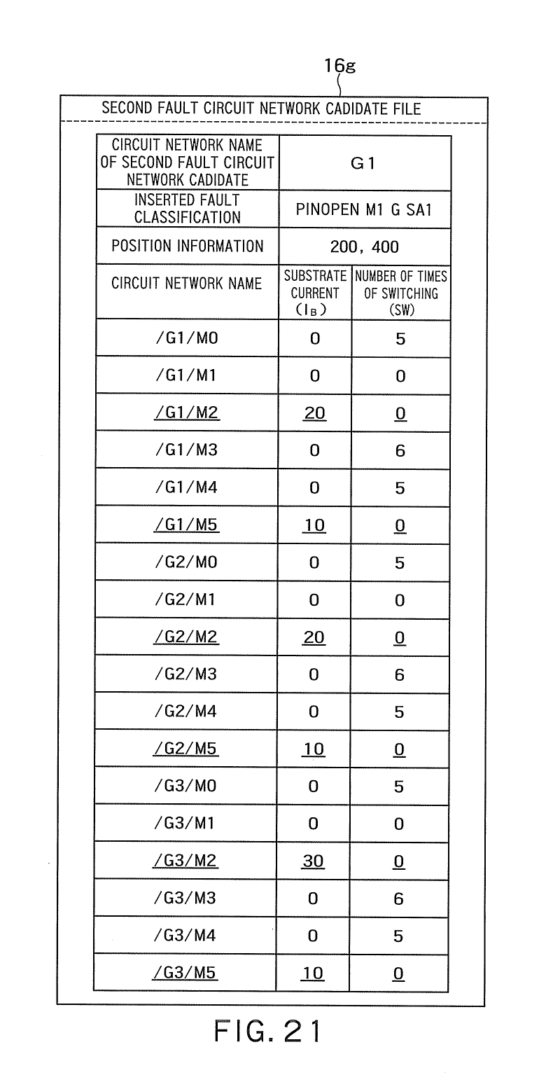

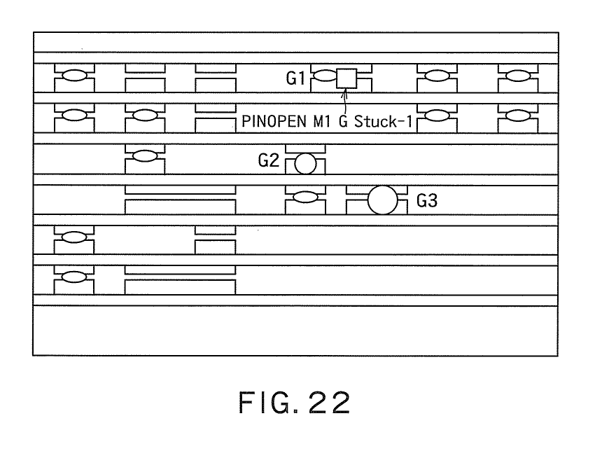

Operation of the diagnostic apparatus according to the second embodiment of the present invention will now be described with reference to the drawings. FIG. 16 is a schematic diagram showing an example of a light emission image which is an analysis result of light emission analysis conducted by using a typical light emission analyzing apparatus. FIG. 17 is a schematic diagram showing a layout of a semiconductor device to be made a diagnosis according to the second embodiment of the present invention. FIG. 18 is a schematic diagram showing a data structure of the fault cell list file 16d shown in FIG. 1 according to the second embodiment of the present invention. FIG. 19 is a schematic diagram showing an example of a data structure of the light emission point dictionary 16f shown in FIG. 1 according to the second embodiment of the present invention. FIG. 20 is a schematic diagram showing an example of comparison of a light emission pattern of a light emission image with a light emission pattern of a simulation result according to the second embodiment of the present invention. FIG. 21 is a schematic diagram showing a data structure of the second fault circuit network candidate file 16g shown in FIG. 1 according to the second embodiment of the present invention. FIG. 22 is a schematic diagram showing an example of an overlay image according to the second embodiment of the present invention.

In the diagnostic processing according to the second embodiment of the present invention, an input step (S501) is first conducted as shown in FIG. 5. In the input step (S501), the input unit 12 accepts light emission image information and design information of the whole semiconductor device from the user's commands. Therefore, the light emission image information file 16b includes the light emission quantity and light emission position information of the whole semiconductor device. As for the light emission image on the whole semiconductor device, light emission points are present on the whole surface as shown in FIG. 16. Therefore, abnormal light emission due to fault operation and light emission due to normal operation are easily overlapped, and it is more difficult to locate the fault point.

Next, a fault cell list generation step (S502) is conducted as shown in FIG. 5. In the fault cell list generation step (S502), the fault cell list generation unit 14a executes a typical fault diagnostic tool implemented by software or the like to store a cell name of a cell having the highest score for the design information (i.e., a cell having the highest possibility of a fault) in the fault cell list file 16d. In addition, the fault cell list generation unit 14a generates a transistor circuit network list and a diagnostic pattern in the same way as the first embodiment of the present invention. For example, the fault cell list generation unit 14a compares the light emission points (see FIG. 16) in the light emission image with the layout (see FIG. 17) in the design information file 16c to store a cell name (cell “G1”) of a cell disposed in a stage preceding cells “G2” and “G3” disposed in the light emission points in the fault cell list file 16d (see FIG. 18).

Next, a fault dictionary generation step (S503) is conducted as shown in FIG. 5. In the fault dictionary generation step (S503), the fault dictionary generation unit 14b extracts first fault circuit network candidates from among circuit networks of fault cell candidates to generate a fault dictionary, on the basis of the design information and the fault cell list. For example, the fault dictionary generation unit 14b stores a circuit network name of a circuit network (first fault circuit network candidate) of a cell having the highest possibility of a fault and its fault classification in the fault dictionary file 16e (see FIG. 8).

Next, a light emission point dictionary generation step (S504) is conducted as shown in FIG. 5. In the light emission point dictionary generation step (S504), on the basis of the light emission image information, design information, diagnostic pattern and fault dictionary, the light emission point dictionary generation unit 14c executes simulation concerning the substrate current and the number of times of switching of a transistor in a cell with the first fault circuit network candidate inserted therein to generate a light emission point dictionary including the substrate current and the number of times of switching of the transistor in the cell with the first fault circuit network candidate inserted therein. For example, the light emission point dictionary generation unit 14c applies a fault classification corresponding to the circuit network name of a first fault circuit network candidate in the fault dictionary file 16e to the transistor circuit network list, applies a diagnostic pattern to the transistor circuit network list, executes simulation concerning the substrate current and the number of times of switching of transistors, and stores a simulation result in the light emission point dictionary file 16f (see FIG. 19). As shown in FIG. 19, the light emission point dictionary includes identification information (circuit network name) of a first fault circuit network candidate, a fault classification inserted in the first fault circuit network candidate, position information of the first fault circuit network candidate, and a simulation result (a substrate current (I_{B}) and the number of times of switching (SW) of the transistor).

Next, a fault circuit network extraction step (S505) is conducted as shown in FIG. 5. In the fault circuit network extraction step (S505), on the basis of the light emission image information, design information and the light emission point dictionary, the fault circuit network extraction unit 14d extracts a second fault circuit network candidate from among the first fault circuit network candidates. For example, the fault circuit network extraction unit 14d compares the light emission pattern of the analysis result of the light emission analysis with the light emission pattern of the simulation result every cell using a correlation between the substrate current (Isub) and light emission quantity (photon) of a transistor shown in FIG. 11, and stores a first fault circuit network candidate in which they nearly coincide with each other in the comparison result in the second fault circuit network candidate file 16g. In the example shown in FIG. 20, the light emission pattern of the analysis result of the light emission analysis nearly coincides with the light emission pattern of the simulation result, corresponding to the first fault circuit network candidate in the light emission point dictionary file 16f, as a result of the comparison. Therefore, the fault circuit network extraction unit 14d stores the light emission point dictionary of the first fault circuit network candidate in the second fault circuit network candidate file 16g (see FIG. 21).

Next, in the output step (S506), the output unit 18 outputs the diagnostic image in the same manner as the first embodiment of the present invention as shown in FIG. 5. For example, the output unit 18 combines a layout image of the design information in the design information file 16c, mark images every inserted fault classifications in the second fault circuit network candidate file 16g and a mark image indicating position information of the light emission point, to generate an overlay image (see FIG. 22), and outputs the overlay image as a diagnostic image (diagnostic result).

As shown in FIG. 5, the diagnostic processing according to the second embodiment of the present invention is ended after the output step (S506).

Paying attention to the cell “G1” and the cells “G2” and “G3” disposed in a stage subsequent to the cell “G1”, the second embodiment of the present invention has been described. However, the second embodiment of the present invention is not restricted to this. The second embodiment of the present invention can be applied to other cells as well in the same way.

According to the second embodiment of the present invention, the light emission pattern of the analysis result of the light emission analysis is compared with the light emission pattern of the simulation result to extract the second fault circuit network candidate every cell. Therefore, even if the light emission point of the analysis result of the light emission analysis has a size which is nearly as large as the size of a transistor, a fault point can be located.

At least a portion of the diagnostic apparatus according to the above-described embodiments of the present invention may be composed of hardware or software. When at least a portion of the diagnostic apparatus is composed of software, a program for executing at least some functions of the diagnostic apparatus may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the diagnostic apparatus according to the above-described embodiment of the present invention may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

The above-described embodiments of the present invention are just illustrative, but the invention is not limited thereto. The technical scope of the invention is defined by the appended claims, and various changes and modifications of the invention can be made within the scope and meaning equivalent to the claims.

What is claimed is:

1. A diagnostic apparatus for semiconductor device comprising:
a fault cell list generation unit configured to extract fault cell candidates corresponding to light emission position information in light emission image information and to generate a fault cell list on the basis of the light emission image information comprising light emission quantities and the light emission position information of transistors of respective cells in a semiconductor device acquired by light emission analysis and design information comprising a layout of the semiconductor device, and to generate a transistor circuit network list showing connection relations of the transistors and a diagnostic pattern on the basis of the design information;
a light emission point dictionary generation unit configured to execute simulation concerning a substrate current of a transistor in a cell with a first fault circuit network candidate inserted therein and to generate a light emission point dictionary comprising a substrate current of the transistor in the cell with the first fault circuit network candidate inserted therein, on the basis of the design information, the diagnostic pattern and a fault dictionary;
a fault circuit network extraction unit configured to extract a second fault circuit network candidate from among the first fault circuit network candidates, on the basis of the light emission image information, the design information and the light emission point dictionary; and
an output unit configured to output the second fault circuit network candidate.

2. The diagnostic apparatus for semiconductor device according to claim 1, wherein the light emission point dictionary generation unit generates a light emission point dictionary further comprising position information of the first fault circuit network candidates, identification information of the first fault circuit network candidates, kinds of faults inserted for the first fault circuit network candidates, and substrate current.

3. The diagnostic apparatus for semiconductor device according to claim 1, wherein the fault circuit network extraction unit compares the light emission quantity and light emission position information in the light emission image information with a substrate current and position information in the light emission point dictionary generated by the light emission point dictionary generation unit, and extracts a first fault circuit network candidate as the second fault circuit network candidate when the light emission image information and the light emission point dictionary nearly coincide.

4. The diagnostic apparatus for semiconductor device according to claim 1, wherein the output unit applies position information of the second fault circuit network candidate extracted by the fault circuit network extraction unit to the design information to output a diagnostic image.

5. The diagnostic apparatus for semiconductor device according to claim 2, wherein the fault circuit network extraction unit compares the light emission quantity and light emission position information in the light emission image information with a substrate current and position information in the light emission point dictionary generated by the light emission point dictionary generation unit, and extracts a first fault circuit network candidate as the second fault circuit network candidate when the light emission image information and the light emission point dictionary nearly coincide.

6. The diagnostic apparatus for semiconductor device according to claim 2, wherein the output unit applies position information of the second fault circuit network candidate extracted by the fault circuit network extraction unit to the design information to output a diagnostic image.

7. The diagnostic apparatus for semiconductor device according to claim 3, wherein the output unit applies position information of the second fault circuit network candidate extracted by the fault circuit network extraction unit to the design information to output a diagnostic image.

8. A diagnostic method for semiconductor device comprising:
generating a fault cell list corresponding to light emission position information in light emission image information, on the basis of the light emission image information comprising light emission quantities and the light emission position information of transistors of respective cells in a semiconductor device acquired by light emission analysis and design information comprising a layout of the semiconductor device;
generating a transistor circuit network list showing connection relations of the transistors and a diagnostic pattern on the basis of the design information;
executing simulation concerning a substrate current of a transistor in a cell with a first fault circuit network candidate inserted therein, on the basis of the design information, the diagnostic pattern and a fault dictionary, to generate a light emission point dictionary comprising a substrate current of the transistor in the cell with the first fault circuit network candidate inserted therein;
extracting a second fault circuit network candidate from among the first fault circuit network candidates, on the basis of the light emission image information, the design information and the light emission point dictionary; and
outputting the second fault circuit network candidate.

9. The diagnostic method for semiconductor device according to claim 8, wherein in generating the light emission point dictionary, a light emission point dictionary further comprising position information of the first fault circuit network candidates, identification information of the first fault circuit network candidates, kinds of faults inserted for the first fault circuit network candidates, and substrate current is generated.

10. The diagnostic method for semiconductor device according to claim 8, wherein in extracting the second fault circuit network candidate, the light emission quantity and light emission position information in the light emission image information is compared with a substrate current and position information in the light emission point dictionary, and a first fault circuit network candidate as the second fault circuit network candidate when the light emission image information and the light emission point dictionary nearly coincide.

11. The diagnostic method for semiconductor device according to claim 8, wherein in outputting the second fault circuit network candidate, position information of the second fault circuit network candidate is applied to the design information to output a diagnostic image.

12. The diagnostic method for semiconductor device according to claim 9, wherein in extracting the second fault circuit network candidate, the light emission quantity and light emission position information in the light emission image information is compared with a substrate current and position information in the light emission point dictionary, and a first fault circuit network candidate in which they nearly coincide is extracted as the second fault circuit network candidate when the light emission image information and the light emission point dictionary nearly coincide.

13. The diagnostic method for semiconductor device according to claim 9, wherein in outputting the second fault circuit network candidate, position information of the second fault circuit network candidate is applied to the design information to output a diagnostic image.

14. The diagnostic method for semiconductor device according to claim 10, wherein in outputting the second fault circuit network candidate, position information of the second fault circuit network candidate is applied to the design information to output a diagnostic image.

15. A medium storing a diagnostic program for semiconductor device, the program comprising:
a fault cell list generation instruction configured to extract fault cell candidates corresponding to light emission position information in light emission image information and to generate a fault cell list on the basis of the light emission image information comprising light emission quantities and the light emission position information of transistors of respective cells in a semiconductor device acquired by light emission analysis and design information comprising a layout of the semiconductor device, and to generate a transistor circuit network list showing connection relations of the transistors and a diagnostic pattern on the basis of the design information;
a light emission point dictionary generation instruction configured to execute simulation concerning a substrate current of a transistor in a cell with a first fault circuit network candidate inserted therein and to generate a light emission point dictionary comprising a substrate current of the transistor in the cell with the first fault circuit network candidate inserted therein, on the basis of the design information, the diagnostic pattern and a fault dictionary;
a fault circuit network extraction instruction configured to extract a second fault circuit network candidate from among the first fault circuit network candidates, on the basis of the light emission image information, the design information and the light emission point dictionary; and
an output instruction configured to output the second fault circuit network candidate.

16. The medium according to claim 15, wherein the light emission point dictionary generation instruction is configured to generate a light emission point dictionary further comprising position information of the first fault circuit network candidates, identification information of the first fault circuit network candidates, kinds of faults inserted for the first fault circuit network candidates, and substrate current.

17. The medium according to claim 15, wherein the fault circuit network extraction instruction is configured to compare the light emission quantity and light emission position information in the light emission image information with a substrate current and position information in the light emission point dictionary generated by the light emission point dictionary generation instruction, and to extract a first fault circuit network candidate as the second fault circuit network candidate when the light emission image information and the light emission point dictionary nearly coincide.

18. The medium according to claim 15, wherein the output instruction is configured to apply position information of the second fault circuit network candidate extracted by the fault circuit network extraction instruction to the design information to output a diagnostic image.

19. The medium according to claim 16, wherein the fault circuit network extraction instruction is configured to compare the light emission quantity and light emission position information in the light emission image information with a substrate current and position information in the light emission point dictionary generated by the light emission point dictionary generation instruction, and to extract a first fault circuit network candidate as the second fault circuit network candidate when the light emission image information and the light emission point dictionary nearly coincide.

20. The medium according to claim 16, wherein the output instruction is configured to apply position information of the second fault circuit network candidate extracted by the fault circuit network extraction instruction to the design information to output a diagnostic image.
